(19) United States
(12) Patent Application Publication
(10) Pub. No.: US 2009/0269611 A1
(43) Pub. Date: Oct. 29, 2009

(54) METAL-COATED STEEL STRIP

(75) Inventors: Qiyang Liu, New South Wales (AU); Wayne Renshaw, New South Wales (AU); Joe Williams, New South Wales (AU)

Correspondence Address: MICHAEL BEST & FRIEDRICH LLP, 100 E WISCONSIN AVENUE, Suite 3300, MILWAUKEE, WI, 53202, US

(73) Assignee: BLUESCOPE STEEL LIMITED, Melbourne, Victoria (AU)

(21) Appl. No.: 12/439,579

(22) PCT Filed: Aug. 29, 2007
(86) PCT No.: PCT/AU2007/001240

§ 371 Date: May 12, 2009

(30) Foreign Application Priority Data
Aug. 29, 2006 (AU) 2006904713

(51) Int. Cl. C23C 2/02; C23C 2/12; C23C 2/06; B32B 15/01

(52) U.S. Cl. 428/653; 427/319

(57) ABSTRACT

A steel strip having a coating of a metal alloy on at least one surface of the strip is disclosed. The metal alloy contains aluminium, zinc, silicon, and magnesium as the major elements. The metal alloy also contains strontium and/or calcium and unavoidable impurities and optionally other elements that are present as deliberate alloying elements. The concentration of magnesium is at least 1 wt. % and the concentration of (i) strontium or (ii) calcium or (iii) strontium and calcium is greater than 50 ppm.

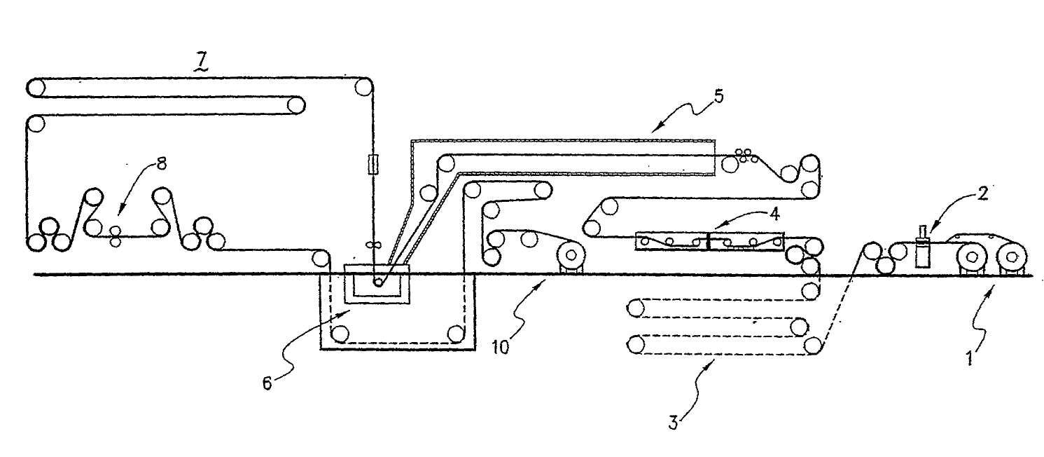

The present invention relates to steel strip that has a corrosion-resistant metal alloy coating that is formed on the strip by hot-dip coating the strip in a molten bath of a metal alloy.

The present invention relates particularly to a corrosion-resistant metal alloy coating that contains aluminium-zinc-silicon-magnesium as the main elements in the alloy, and is hereinafter referred to as an “Al—Zn—Si—Mg alloy” on this basis, and also contains strontium and/or calcium, and unavoidable impurities and, optionally, other elements that are present as deliberate alloying elements.

The present invention relates particularly but not exclusively to steel strip that is coated with the above-described Al—Zn—Si—Mg alloy and can be cold formed (e.g. by roll forming) into an end-use product, such as roofing products.

The present invention relates more particularly but not exclusively to Al—Zn—Si—Mg alloy coated steel strip of the type described in the preceding paragraphs that has a corrosion-resistant coating with small spangles, i.e. a coating with an average spangle size of the order of less than 0.5 mm.

Typically, the Al—Zn—Si—Mg alloy comprises the following ranges in % by weight of the elements aluminium, zinc, silicon, and magnesium:

aluminium: 40 to 60% by weight;

zinc: 40 to 60% by weight;

silicon: 0.3 to 3% by weight; and

magnesium 0.3 to 10% by weight.

In the conventional hot-dip metal coating method, steel strip generally passes through one or more heat treatment furnaces and thereafter into and through a bath of molten metal alloy, such as aluminium-zinc-silicon alloy, held in a coating pot. The heat treatment furnaces may be arranged so that the strip travels horizontally through the furnaces. The heat treatment furnaces may also be arranged so that the strip travels vertically through the furnaces and passes around a series of upper and lower guide rollers. The heat treatment furnace that is adjacent a coating pot has an outlet snout that extends downwardly to a location below an upper surface of the bath. The metal alloy is usually maintained molten in the coating pot by the use of heating inductors. The strip usually exits the heat treatment furnaces via an outlet end section in the form of an elongated furnace exit chute or snout that dips into the bath. Within the bath the strip passes around one or more sink rolls and is taken upwardly out of the bath and is coated with the metal alloy as it passes through the bath. After leaving the coating bath the metal alloy coated strip passes through a coating thickness control station, such as a gas knife or gas wiping station, at which its coated surfaces are subjected to jets of wiping gas to control the thickness of the coating. The metal alloy coated strip then passes through a cooling section and is subjected to forced cooling. The cooled metal alloy coated strip may thereafter be optionally conditioned by passing the coated strip successively through a skin pass rolling section (also known as a temper rolling section) and a tension levelling section. The conditioned strip is coiled at a coiling station.

In general terms, the present invention is concerned with providing metal alloy coated steel strip that is an improved product when compared with currently available products from the viewpoint of a combination of properties of corrosion resistance, ductility, cosmetic appearance, and surface defects of the coating.

The term “surface defects” is understood herein to mean defects on the surface of a coating that are described by the applicant as “rough coating” and “pinhole-uncoated” defects.

Typically, a “rough coating” defect is a region that has a substantial variation in coating over a 1 mm length of strip, with the thickness varying between 10 micrometers thick and 40 micrometers thick.

Typically, a “pinhole-uncoated” defect is a very small region (<0.5 mm in diameter) that is uncoated.

International application PCT/AU2004/000345 (WO 2-004/083480) in the name of the applicant describes a method of controlling surface defects of the type described above on a steel strip coated with an aluminium-zinc-silicon alloy, which may also contain magnesium, which includes the steps of: successively passing the steel strip through a heat treatment furnace and a bath of molten aluminium-zinc-silicon alloy, and:

(a) heat treating the steel strip in the heat treatment furnace; and

(b) hot-dip coating the strip in the molten bath and thereby forming a coating of the metal alloy on the steel strip; and

which method is characterised by controlling the concentration of (i) strontium or (ii) calcium or (iii) strontium and calcium in the molten bath to be at least 2 ppm.

The International application describes that: (a) the applicant believes that oxides on the surface of a molten bath are one major cause of the above-described surface defects, (b) the surface oxides are solid oxides that are formed from metals in the molten bath as a result of reactions between molten bath metal alloy and water vapour above the molten bath in an outlet snout of an adjacent heat treatment furnace, and (c) the surface oxides are taken up by strip as the strip passes through the oxide layer as it enters the molten bath.

The International application is based on a finding that small amounts of strontium and calcium separately and in combination in the molten bath inhibit or improve the nature of the oxide that forms on the melt surface in the snout, thereby minimising the number of surface defects on coated strip.

The general teaching of the International application is that amounts of strontium and/or calcium towards a lower limit of 2 ppm rather than towards an upper limit of 150 ppm mentioned in the International application are preferred.

In further work since lodging the International application the applicant has found that magnesium in the molten bath makes the oxide that forms on the melt surface much worse than was previously anticipated. This is a significant issue because magnesium is an important element in the metal alloy because it improves the corrosion resistance of coated strip.

With the above in mind, the applicant has realised that it is important to use higher concentrations of strontium and/or calcium in Al—Zn—Si—Mg alloys than is required in Al—Zn—Si alloys, particularly such Al—Zn—Si—Mg alloys that have concentrations of magnesium above 1%.

The applicant has also realised that there is an upper limit to the amount of strontium and/or calcium in a molten metal alloy bath containing Al—Zn—Si—Mg alloys because there are issues relating to oxide dross formation on the bath surface outside the outlet snout of an adjacent heat treatment furnace and maintaining concentration levels in the molten bath-greater losses occur due to oxidation of the strontium and calcium itself.

In this context, the applicant believes that, typically, concentrations of (i) strontium or (ii) calcium or (iii) strontium and calcium together of greater than 50 ppm and less than 100 ppm are required for Al—Zn—Si—Mg alloys containing 1-5 wt. % Mg.

In general terms, the present invention provides a steel strip having a coating of a metal alloy on at least one surface of the strip, wherein the metal alloy contains aluminium, zinc, silicon, and magnesium (“Al—Zn—Si—Mg”) as the major elements and also contains strontium and/or calcium and unavoidable impurities and optionally other elements that are present as deliberate alloying elements, and wherein the concentration of magnesium is at least 1 wt. % and the concentration of (i) strontium or (ii) calcium or (iii) strontium and calcium together is greater than 50 ppm.

The strontium and the calcium may be added separately or in combination.

Preferably the concentration of (i) strontium or (ii) calcium or (iii) strontium and calcium together is greater than 60 ppm.

Preferably the concentration of (i) strontium or (ii) calcium or (iii) strontium and calcium together is less than 0.2 wt. %.

More preferably the concentration of (i) strontium or (ii) calcium or (iii) strontium and calcium together is less than 150 ppm.

Typically the concentration of (i) strontium or (ii) calcium or (iii) strontium and calcium together is less than 100 ppm.

Preferably the magnesium concentration is less than 10% by weight.

Preferably the magnesium concentration is less than 5 wt. %.

Preferably the magnesium concentration is less than 3 wt. %.

Preferably the magnesium concentration is at least 0.5 wt. %.

Preferably the magnesium concentration is at least 1 wt. % and less than 5 wt. %.

More preferably the magnesium concentration is between 1.5 wt. % and 3 wt. %.

Preferably the aluminium, zinc, silicon, and magnesium alloy is a titanium diboride-modified alloy such as described in International application PCT/US00/23164 (publication WO 01/27343) in the name of Bethlehem Steel Corporation. The disclosure in the specification of the International application is incorporated herein by cross-reference. The International application discloses that titanium diboride minimises the spangle size of aluminium-zinc-silicon alloys.

The aluminium, zinc, silicon, and magnesium alloy may contain other elements. By way of example, the other elements may include any one or more of indium, tin, beryllium, titanium, copper, nickel, cobalt, and manganese.

Preferably the aluminium, zinc, silicon, and magnesium alloy does not contain vanadium and/or chromium as deliberate alloy elements—as opposed to being present in trace amounts for example due to contamination in the molten bath.

The term “unavoidable impurities” is understood herein to mean elements that are present typically in relatively small amounts, not as a consequence of specific additions of these elements but as a consequence of standard production.

By way of example, iron is an unavoidable impurity by virtue of dissolution of strip passing through the coating bath and pot equipment.

Preferably the concentration of iron is less than 1 wt. %.

The strip coated with aluminium, zinc, silicon, and magnesium coating alloy may have small spangles.

The term “small spangles” is understood herein to mean metal coated strip that has spangles that are less than 0.5 mm, preferably less than 0.2 mm, measured using the average intercept distance method as described in Australian Standard AS1733.

The strip may be coated on one or both sides thereof.

Preferably the strip has a metallic coating mass of less than 80 g/m² of metal alloy on the or each side of the strip.

More preferably the strip has a metallic coating mass of less than 60 g/m² of metal alloy on the or each side of the strip.

Preferably the average metallic coating thickness is less than 20 micrometers on the or each side of the strip.

The present invention also provides a method of forming a coating of a metal alloy on at least one surface of a steel strip, wherein the metal alloy contains aluminium, zinc, silicon, and magnesium as the major elements and also contains strontium and/or calcium and unavoidable impurities and optionally other elements that are present as deliberate alloying elements, and wherein the concentration of magnesium is at least 0.5 wt. % and the concentration of (i) strontium or (ii) calcium or (iii) strontium and calcium together is greater than 50 ppm, which method includes the steps of successively passing the steel strip through a heat treatment furnace and a molten bath that contains the metal alloy, and:

(a) heat treating the steel strip in the heat treatment furnace; and

(b) hot-dip coating the strip in the molten bath and forming a coating of the metal alloy on the steel strip.

Preferably the concentration of (i) strontium or (ii) calcium or (iii) strontium and calcium together in the metal alloy is greater than 60 ppm.

Preferably the concentration of (i) strontium or (ii) calcium or (iii) strontium and calcium together in the metal alloy is less than 0.2 wt. %.

More preferably the concentration of (i) strontium or (ii) calcium or (iii) strontium and calcium together is less than 150 ppm.

Typically, the concentration of (i) strontium or (ii) calcium or (iii) strontium and calcium together is less than 100 ppm.

One option for providing strontium and/or calcium in the metal alloy is to specify a minimum concentration(s) of strontium and/or calcium in the aluminium, zinc or pre-mixed aluminium-zinc alloy ingots that are supplied to form the aluminium, zinc, silicon, and magnesium coating alloy for the molten bath.

Another, although not the only other, option is to periodically dose the molten bath with amounts of strontium and/or calcium that are required to maintain the concentration(s) at a required concentration.

Preferably the strip has a coating mass of less than 80 g/m² of metallic coating on the or each side of the strip.

More preferably the strip has a coating mass of less than 60 g/m² of metallic coating on the or each side of the strip.

Preferably the strip has an average coating thickness of less than 20 micrometers on the or each side of the strip.

Optionally, the strip has small spangles, i.e. spangles that are less than 0.5 mm, preferably less than 0.2 mm, measured using the average intercept distance method as described in Australian Standard AS1733.

Small spangles may be formed by any suitable method steps, such as by adding titanium diboride particles (which term includes powders) to the molten bath as described in International application PCT/US00/23164 (WO 01/27343) in the name of Bethlehem Steel Corporation.

Preferably the heat treatment furnace has an elongated furnace exit chute or snout that extends into the bath.

According to the present invention there is also provided cold formed products made from the above-described metal alloy coated steel strip.

The present invention is described further by way of example with reference to the accompanying drawing which is a schematic drawing of one embodiment of a continuous production line for producing steel strip coated with Al—Zn—Si—Mg alloy in accordance with the method of the present invention.

With reference to the FIGURE, in use, coils of cold rolled steel strip are uncoiled at an uncoiling station 1 and successive uncoiled lengths of strip are welded end to end by a welder 2 and form a continuous length of strip.

The strip is then passed successively through an accumulator 3, a strip cleaning section 4 and a furnace assembly 5.

The furnace assembly 5 includes a preheater, a preheat reducing furnace, and a reducing furnace.

The strip is heat treated in the furnace assembly by careful control of process variables including: (i) the temperature profile in the furnaces, (ii) the reducing gas concentration in the furnaces, (iii) the gas flow rate through the furnaces, and (iv) strip residence time in the furnaces (i.e. line speed).

The process variables in the furnace assembly 5 are controlled so that there is removal of iron oxide residues from the surface of the strip and removal of residual oils and iron fines from the surface of the strip.

The heat treated strip is then passed via an outlet snout downwardly into and through a bath containing a molten metal alloy held in a coating pot 6 and is coated with the metal alloy.

The metal alloy is an Al—Zn—Si—Mg coating alloy that contains:

(a) at least 0.5 wt. % and less than 10 wt. % magnesium to contribute to corrosion resistance of the coating,

(b) titanium didiborides to minimise spangle size of the coating, and

(c) more than 50 ppm and less than 0.2 wt. % strontium and calcium together to minimise the number of the above-described surface defects.

Preferably the metal alloy does not contain vanadium and/or chromium.

Typically, the metal alloy contains incidental impurities, such as iron.

The metal alloy is maintained molten in the coating pot by use of heating inductors (not shown).

Within the bath the strip passes around a sink roll and is taken upwardly out of the bath. Both surfaces of the strip are coated with the metal alloy in the bath as it passes through the bath.

The coating that forms on the strip in the molten bath is in the form of the metal alloy.

The coating has a comparatively smaller number of the above-described surface defects due to the strontium and calcium.

The coating has small spangles due to the titanium diboride.

After leaving the molten bath 6 the coated strip passes vertically through a gas wiping station (not shown) at which its coated surfaces are subjected to jets of wiping gas to control the thickness of the coating.

The coated strip is then passed through a cooling section 7 and subjected to forced cooling.

The cooled, coated strip, is then passed through a rolling section 8 that conditions the surface of the coated strip.

The coated strip is thereafter coiled at a coiling station 10.

Many modifications may be made to the preferred embodiment described above without departing from the spirit and scope of the present invention.

1. A steel strip having a coating of a metal alloy on at least one surface of the strip, wherein the metal alloy contains aluminium, zinc, silicon, and magnesium as the major elements and also contains strontium and/or calcium and unavoidable impurities and optionally other elements that are present as deliberate alloying elements, and wherein the concentration of aluminium is 40 to 60 wt. %, the concentration of zinc is 40 to 60 wt. %, the concentration of silicon is 0.3 to 3 wt. %, the concentration of magnesium is at least 1 wt. % and the concentration of (i) strontium or (ii) calcium or (iii) strontium and calcium together is greater than 50 ppm.

2. The steel strip defined in claim 1 wherein the concentration of (i) strontium or (ii) calcium or (iii) strontium and calcium together is less than 0.2 wt. %.

3. The steel strip defined in claim 1 wherein the concentration of (i) strontium or (ii) calcium or (iii) strontium and calcium together is less than 150 ppm.

4. The steel strip defined in claim 1 wherein the concentration of (i) strontium or (ii) calcium or (iii) strontium and calcium together is less than 100 ppm.

5. The steel strip defined in claim 1 wherein the magnesium concentration is less than 10% by weight.

6. The steel strip defined in claim 1 wherein the magnesium concentration is less than 5 wt. %.

7. The steel strip defined in claim 1 wherein the magnesium concentration is less than 3 wt. %.

8. The steel strip defined in claim 1 wherein the magnesium concentration is at least 0.5 wt. %.

9. The steel strip defined in claim 1 wherein the magnesium concentration is at least 1 wt. % and less than 5 wt. %.

10. The steel strip defined in claim 1 wherein the magnesium concentration is between 1.5 wt. % and 3 wt. %.

11. The steel strip defined in claim 1 wherein the aluminium, zinc, silicon, and magnesium alloy is a titanium diboride-modified alloy as defined herein.

12. The steel strip defined in claim 1 wherein the aluminium, zinc, silicon, and magnesium alloy contains any one or more of indium, tin, beryllium, titanium, copper, nickel, cobalt, and manganese.

13. The steel strip defined in claim 1 wherein the aluminium, zinc, silicon, and magnesium alloy does not contain vanadium and/or chromium as deliberate alloy elements—as opposed to being present in trace amounts for example due to contamination in the molten bath.

14. The steel strip defined in claim 1 wherein the concentration of iron is less than 1 wt. %.

15. The steel strip defined in claim 1 wherein the coating has small spangles as defined herein.

16. The steel strip defined in claim 1 wherein the strip is coated on one or both sides thereof.

17. The steel strip defined in claim 1 wherein the coating has a coating mass of less than 80 g/m² of metal alloy on the or each side of the strip.

18. The steel strip defined in claim 1 wherein the coating has an average coating thickness of less than 20 micrometers on the or each side of the strip.

19. A method of forming a coating of a metal alloy on at least one surface of a steel strip, wherein the metal alloy contains aluminium, zinc, silicon, and magnesium as the major elements and also contains strontium and/or calcium and unavoidable impurities and optionally other elements that are present as deliberate alloying elements, and wherein the concentration of aluminium is 40 to 60 wt. %, the concentration of zinc is 40 to 60 wt. %, the concentration of silicon is 0.3 to 3 wt. %, the concentration of magnesium is at least 0.5 wt. % and the concentration of (i) strontium or (ii) calcium or (iii) strontium and calcium together is greater than 50 ppm, which method includes the steps of successively passing the steel strip through a heat treatment furnace and a molten bath that contains the metal alloy, and:
(a) heat treating the steel strip in the heat treatment furnace; and
(b) hot-dip coating the strip in the molten bath and forming a coating of the metal alloy on the steel strip.

20. The method defined in claim 19 wherein the concentration of (i) strontium or (ii) calcium or (iii) strontium and calcium together in the metal alloy is less than 0.2 wt. %.

21. The method defined in claim 19 wherein the concentration of (i) strontium or (ii) calcium or (iii) strontium and calcium together is less than 150 ppm.

22. The method defined claim 19 wherein the concentration of (i) strontium or (ii) calcium or (iii) strontium and calcium together is less than 100 ppm.

23. The method defined claim 19 wherein step (b) includes forming the coating with a coating mass of less than 80 g/m² of metallic coating on the or each side of the strip.

24. The method defined in claim 19 wherein step (b) includes forming the coating with an average coating thickness of less than 20 micrometers on the or each side of the strip.

25. The method defined in claim 19 wherein step (b) includes forming the coating with small spangles as defined herein.

26. Cold formed products made from the metal alloy coated steel strip defined in claim 1.

27. A steel strip having a coating of a metal alloy on at least one surface of the strip, wherein the metal alloy contains aluminium, zinc, silicon, and magnesium as the major elements and also contains strontium and/or calcium and unavoidable impurities and optionally other elements that are present as deliberate alloying elements, and wherein the concentration of aluminium is 40 to 60 wt. %, the concentration of zinc is 40 to 60 wt. %, the concentration of silicon is 0.3 to 3 wt. %, the concentration of magnesium is at least 1 wt. % and less than 3 wt. % and the concentration of (i) strontium or (ii) calcium or (iii) strontium and calcium together is greater than 50 ppm and less than 0.2 wt. %.
